(19) United States
(12) Patent Application Publication
(10) Pub. No.: US 2024/0119445 A1
(43) Pub. Date: Apr. 11, 2024

(54) PAYMENT SERVICE PROVIDER INTEROPERABILITY FOR DIGITAL PAYMENTS

(71) Applicant: CRUNCHFISH DIGITAL CASH AB, Malmö (SE)

(72) Inventors: Joachim Samuelsson, Helsingborg (SE); Paul Cronholm, Malmö (SE)

(21) Appl. No.: 18/276,991

(22) PCT Filed: Feb. 11, 2022
(86) PCT No.: PCT/SE2022/050152

§ 371 Date: Aug. 11, 2023

(30) Foreign Application Priority Data
Feb. 12, 2021 (SE) 2150159-8
Mar. 1, 2021 (SE) 2150228-1
Nov. 4, 2021 (SE) 2151353-6

(51) Int. Cl. G06Q 20/38; G06Q 20/40

(52) U.S. Cl. CPC G06Q 20/38215; G06Q 20/4014

(57) ABSTRACT

A computerized method (100) of performing a digital payment of a payment amount (Amount) between a payer (P1) and a payee (P2) provides payment service provider interoperability. A payer communication device (PD1) and a payee 5 communication device (PD2) communicate (112) by short-range data communication during an offline settlement stage (110) to generate payment transaction data (Transaction Data) being digitally signed (114) by the payer communication device (PD1). The generated payment transaction data (Transaction Data) is validated (116) by the payee communication device (PD2). The method further has an online settlement 10 stage (130) during which the payment transaction data (Transaction Data) is communicated (132) to a computerized payment network switch (NW) that validates (136) the payment transaction data (Transaction Data), and communicates (142) with a first payment service provider (PSP1) to cause a deduction of funds from a payer account (account_P1) and an addition of funds to a payee account (account_P2), 15 corresponding to the payment amount (Amount).

### TECHNICAL FIELD

The present invention generally relates to the field of digital payments. More particularly, the present invention relates to technical improvements for digital payments between payers and payees that are physically proximate to each other, e.g. that appear or meet at a physical place such as, for instance, a shop, restaurant, theatre, sport arena, workshop, or basically any place where humans can meet to perform a digital payment. Even more particularly, the present invention relates to a digital payment system that enables payment service provider interoperability for digital payments between such proximate users, and to an associated computerized method. Moreover, the invention relates to associated communication devices, cloud-based computing resources, computer program products and computer readable media.

### BACKGROUND

As everybody knows, there has been an overwhelming market penetration for mobile communication devices such as smart phones and tablets at least during the last decade. Long gone are the days when mobile communication devices were primarily used for voice calls. Typically, mobile communication devices are enabled for wide-area network, WAN, communication (broadband RF communication) with remote entities, for instance via cellular radio systems like 5G, UMTS or GSM, or via wireless local area network, WLAN, access for routing IP traffic to and from such remote entities. In addition, mobile communication devices are often enabled for short-range wireless data communication, such as Bluetooth, with other devices nearby. Such a nearby device may for instance be an accessory or peripheral device, like a wireless headset or wireless speakers.

Thanks to their ability for WAN communication, users of mobile communication devices may enjoy a plethora of digital services that involve communication with cloud-based resources. A very popular type of such digital services is digital payments. A special kind of digital payments is the digital proximity payment that allows a user of a mobile communication device to make a digital payment when being physically proximate to another entity at a physical place such as, for instance, a shop, restaurant, theatre, sport arena, workshop, or basically any place where a human may want to perform a digital payment. The other entity may be another communication device which is controlled by a human user (such as a smart phone, tablet, point-of-sales terminal, payment terminal, checkout counter, etc.), or another communication device that operates more autonomously (such as a service terminal, vending machine, ticket machine, access control system, etc.).

At the same time, it is recalled that enormous volumes of digital payments are made by using smart cards (or smart chips) at the payer side.

Throughout this document, the term “digital payment” is to be construed broadly to embrace any kind of transfer of economic value in digital form on behalf of or between people of any types, roles etc.

In the digital payment systems of today, interoperability between payment services is hard to achieve due to payments being settled in a single online step.

The present applicant is a technical pioneer within digital payments with Digital Cash that settles payments in two steps, first offline and then online. This enables payments that always work and can also be made with preserved integrity. Digital Cash is extremely flexible and complements all types of payment schemes, both on cards and mobiles. Reference is for instance made to applicant's international patent application PCT/SE2020/051251, the contents of which are incorporated herein by reference.

### SUMMARY

The present document discloses technical improvements which make digital payment services interoperable, on a national level or even on an international level, through the issuing of a digital certificate structure that may reach global scope. Payment in other countries also becomes possible through handling of exchange rates offline. These improvements may be extremely valuable from an international perspective, as payment schemes—cards, real-time payments, closed-loop wallets, CBDC (Central Bank Digital Currency, i.e. a digital currency (a.k.a. e-currency) issued by a central bank) and crypto currency—can be used over international borders. A national interoperability between different payment schemes is also important, for instance to accelerate the implementation of CBDC. The improvements allow, among many other things, a payer to perform a digital payment to a payee even when the payer communication device is operated in a foreign area (for instance abroad), where the payer communication device has no wide area network access (including cellular network access), for instance because the payer does not hold any valid subscription for such services in the foreign area, or because of technical incompliance.

Applicant's two-tier settlement of payments, first offline and then online, is what enables smooth interoperability of the world's payment services, both cross-border and cross-schemes. The payee verifies that the transaction is legitimate by being able to check the payer's certificate and thereby trust that the payment can be settled online at a later stage. Root certification may be established for Digital Cash services on a global basis that verifies offline payments when the payer and the payee use different payment services or different types of payment rails. An exchange table in the payer's payment app means that the offline balance can also be debited for offline payments in a foreign currency. Any currency differences may be adjusted at the point of online settlement by debiting or crediting the payer's account

In line with the observations above, the present inventors have made valuable technical insights. These insights will be presented as inventive aspects below as well as in the attached independent claims. The list of inventive aspects is not to be seen as exhaustive but rather a summary of particularly beneficial inventive aspects. The inventive aspects will be exemplified by reference to disclosed embodiments which are shown in the enclosed drawings. The inventive aspects are not as such limited to the disclosed embodiments, as the skilled reader will understand.

A first inventive aspect is a digital payment system enabling payment service provider interoperability for digital payments between proximate users. The system comprises a computerized payment network switch, a computerized first payment service provider that handles a payer account of a payer, and a computerized second payment service provider that handles a payee account of a payee. The system further comprises a payer communication device for use by the payer and having a payer communication device digital certificate being verifiable with a pre-installed certificate, and a payee communication device for use by the payee. The functionality of the system and the entities comprised therein is defined in the attached independent system claim, with further refinements thereof in possible (but non-limiting) embodiments being defined in the dependent claims.

A second inventive aspect is a computerized method of performing a digital payment of a payment amount between a payer and a payee according to the attached independent method claim. The computerized method may further comprise any or all of the functionality performed by the payment network switch, the first payment service provider, the second payment service provider, the payer communication device and the payee communication device in the digital payment system according to the first inventive aspect.

A third inventive aspect is a cloud-based computing resource configured to perform the functionality of the payment network switch in the digital payment system according to the first inventive aspect.

A fourth inventive aspect is a cloud-based computing resource configured to perform the functionality of the first payment service provider in the digital payment system according to the first inventive aspect.

A fifth inventive aspect is a cloud-based computing resource configured to perform the functionality of the second payment service provider in the digital payment system according to the first inventive aspect.

A sixth inventive aspect is a communication device configured to perform the functionality of the payer communication device in the digital payment system according to the first inventive aspect. The communication device may, for instance, be a mobile communication device, a mobile phone, a smart phone, a tablet computer, a personal digital assistant, a portable computer, smart glasses, a smart wearable, a smart watch, a smart bracelet, a smart card or a smart chip.

A seventh inventive aspect is a communication device configured to perform the functionality of the payee communication device in the digital payment system according to the first inventive aspect. The communication device may, for instance, be a mobile communication device, a mobile phone, a smart phone, a tablet computer, a personal digital assistant, a portable computer, smart glasses, a smart watch, a smart card, a smart bracelet, a smart wearable, a payment terminal, a service terminal, a point-of-sales terminal, a checkout counter, a delivery pickup point, a vending machine, a ticket machine, a dispensing machine, or an access control system.

An eighth inventive aspect is a computer program product comprising computer program code for performing the functionality of the payment network switch in the method according to the second inventive aspect when the computer program code is executed by a processing device.

A ninth inventive aspect is a computer program product comprising computer program code for performing the functionality of the first payment service provider in the method according to the second inventive aspect when the computer program code is executed by a processing device.

A tenth inventive aspect is a computer program product comprising computer program code for performing the functionality of the second payment service provider in the method according to the second inventive aspect when the computer program code is executed by a processing device.

An eleventh inventive aspect is a computer program product comprising computer program code for performing the functionality of the payer communication device in the method according to the second inventive aspect when the computer program code is executed by a processing device.

A twelfth inventive aspect is a computer program product comprising computer code program for performing the functionality of the payee communication device in the method according to the second inventive aspect when the computer program code is executed by a processing device.

A thirteenth inventive aspect is a computer readable medium having stored thereon a computer program comprising computer program code for performing the functionality of the payment network switch in the method according to the second inventive aspect when the computer program code is executed by a processing device.

A fourteenth inventive aspect is a computer readable medium having stored thereon a computer program comprising computer program code for performing the functionality of the first payment service provider in the method according to the second inventive aspect when the computer program code is executed by a processing device.

A fifteenth inventive aspect is a computer readable medium having stored thereon a computer program comprising computer program code for performing the functionality of the second payment service provider in the method according to the second inventive aspect when the computer program code is executed by a processing device.

A sixteenth inventive aspect is a computer readable medium having stored thereon a computer program comprising computer program code for performing the functionality of the payer communication device in the method according to the second inventive aspect when the computer program code is executed by a processing device.

A seventeenth inventive aspect is a computer readable medium having stored thereon a computer program comprising computer program code for performing the functionality of the payee communication device in the method according to the second inventive aspect when the computer program code is executed by a processing device.

As used in this document, the term “computer readable medium” shall be construed as including tangible (non-volatile) computer readable media.

As used in this document, the term “short-range data communication” includes any form of proximity-based device-to-device communication, unidirectional or bidirectional. This includes radio-based short-range wireless data communication such as, for instance, Bluetooth, BLE (Bluetooth Low Energy), RFID, WLAN, WiFi, mesh communication or LTE Direct, without limitation. It also includes non-radio-based short-range wireless data communication such as, for instance, magnetic communication (such as NFC), audio communication, ultrasound communication, or optical communication (such as QR, barcode, IrDA).

As used in this document, the term “wide area network communication” (abbreviated as “WAN communication”) includes any form of data network communication with a party which may be remote (e.g. cloud-based), including cellular radio communication like W-CDMA, GSM, UTRAN, HSPA, LTE, LTE Advanced or 5G, possibly communicated as TCP/IP traffic, or via a WLAN (WiFi) access point, without limitation. Moreover, the terms “long-range data communication” and “broadband data communication” are considered as synonyms of “wide-area network communication”.

Expressions like “[entity] is configured for . . . [performing activity]” or “[entity] is configured to . . . [perform activity]” will include typical cases where a computerized entity (having one or more controllers, processing units, programmable circuitry, etc.) executes software or firmware installed in the computerized entity, wherein the execution occurs in order to perform the activity in question.

Other aspects, objectives, features and advantages of the inventive aspects will appear from the following detailed disclosure, from the attached dependent claims as well as from the drawings. Generally, all terms used in the claims are to be interpreted according to their ordinary meaning in the technical field, unless explicitly defined otherwise herein.

All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

FIG. 1 is a schematic diagram of a digital payment system that enables payment service provider interoperability for digital payments between proximate users.

FIG. 2A illustrates a first part, namely an offline settlement stage, of a schematic flowchart diagram of a computerized method of performing a digital payment of a payment amount between a payer and a payee.

FIG. 2B illustrates a second part, namely an online settlement stage, of the schematic flowchart diagram of the computerized method of performing a digital payment of a payment amount between a payer and a payee.

FIG. 3 is a schematic block diagram of a communication device that may implement a payer communication device suitable for use in the digital payment system and computerized method.

FIG. 4 is a schematic block diagram of a communication device that may implement a payee communication device suitable for use in the digital payment system and computerized method.

FIG. 5 is a schematic illustration of a computer-readable medium in one exemplary embodiment, capable of storing a computer program product.

FIG. 6 is a schematic signal diagram illustrating distribution of digital certificates in one embodiment of the digital payment system according to the present disclosure.

FIG. 7 is a schematic signal diagram illustrating distribution of foreign exchange rates in one embodiment of the digital payment system according to the present disclosure.

FIG. 8 is a schematic signal diagram illustrating digital cash replenishment of the payer's digital wallet in one embodiment of the digital payment system according to the present disclosure.

FIG. 9 is a schematic signal diagram illustrating offline settlement of a digital payment in one embodiment of the digital payment system according to the present disclosure.

FIGS. 10A and 10B together are a schematic signal diagram illustrating online settlement of a digital payment in one embodiment of the digital payment system according to the present disclosure.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like drawings references refer to like elements throughout, particularly such that an element being referred to as “ynn” in a second drawing is to be understood as the same as or the equivalent of an element being referred to as “xnn” in a first drawing, where x and y are single-digit numbers and nn is a double-digit number. When the same drawings reference is used for an element that appears in multiple drawings, such element is to be understood as being the same or at least equivalent throughout such multiple drawings. Elements illustrated as hatched boxes are generally to be seen as optional in the particular drawing in which they appear.

### Core Embodiments

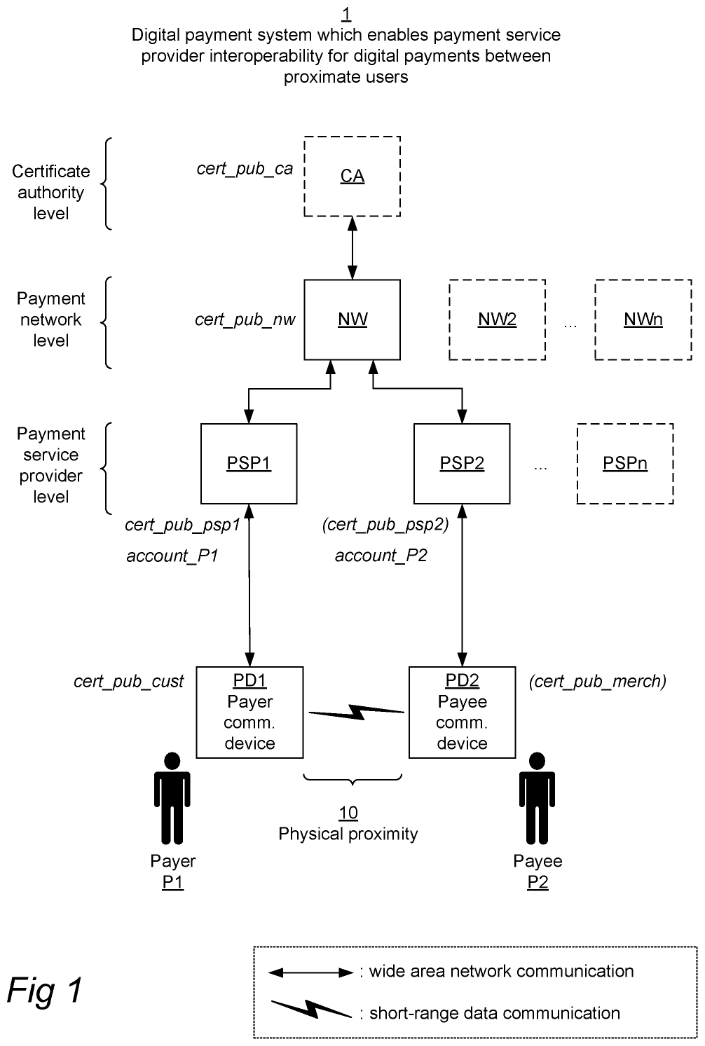

FIG. 1 shows a digital payment system 1 that enables payment service provider interoperability for digital payments between proximate users, here in the form of a payer P1 and payee P2.

The digital payment system 1 in FIG. 1 comprises a payer communication device PD1 for use by the payer P1. The payer communication device PD1 has a payer communication device digital certificate cert_pub_cust which is verifiable with a pre-installed certificate. The digital payment system 1 moreover comprises a payee communication device PD2 for use by the payee P2.

In addition, the digital payment system comprises a computerized payment network switch NW with a pre-installed certificate able to verify cert_pub_cust. In some embodiments, the network switch NW has a pre-installed certificate in the form of a payment network switch digital certificate cert_pub_nw. The digital payment system 1 further comprises a computerized first payment service provider PSP1 that handles a payer account account_P1 of the payer P1 with a pre-installed certificate able to verify cert_pub_cust. In some embodiments the first payment service provider PSP1 has a pre-installed certificate in the form of a first payment service provider digital certificate cert_pub_psp1 which in turn is verifiable with the payment network switch digital certificate cert_pub_nw. Moreover, a computerized second payment service provider PSP2 that handles a payee account account_P2 of the payee P2 is also provided in the digital payment system 1. There may be additional computerized payment service provider PSPn in the digital payment system 1, as can be seen in FIG. 1. The first and second payment service providers PSP1 and PSP2 (and any additional computerized payment service provider PSPn) are typically different payment service providers selected, for instance, among Swish, Klarna, Google Pay, Samsung Pay, Apple Pay and Paytm, without limitation.

Other than being able to verify another digital certificate in the manner described above and in the rest of this document, there are generally no limitations on what may constitute “a pre-installed certificate” (i.e., “a pre-installed digital certificate”), as the skilled person will understand from the teachings of this document assisted by common general knowledge.

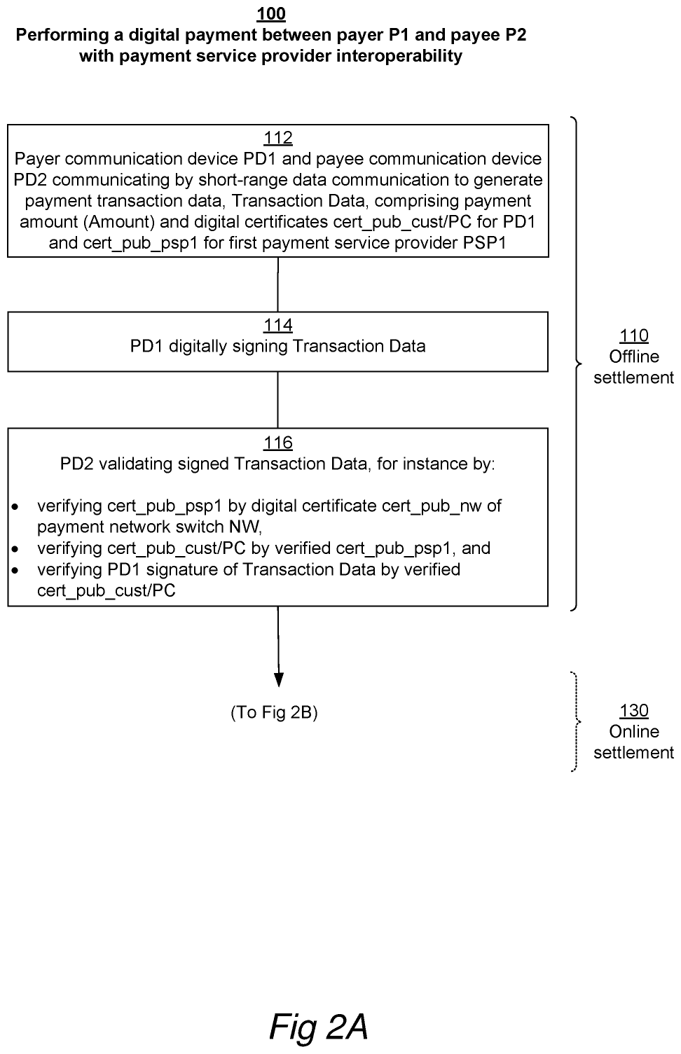

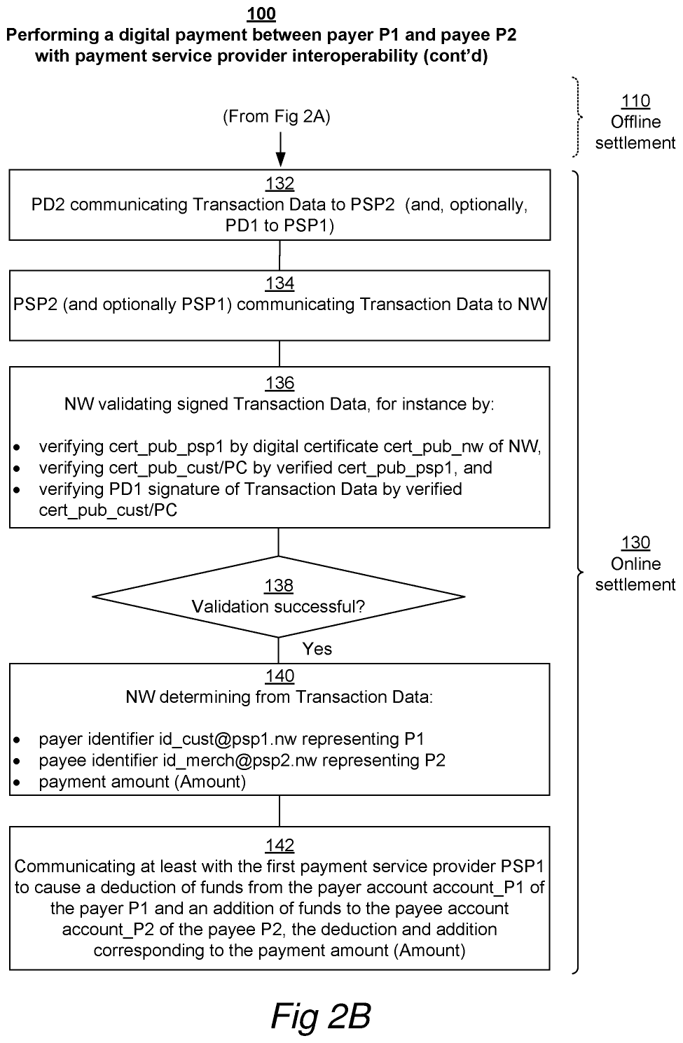

FIGS. 2A and 2B together illustrate a computerized method 100 of performing a digital payment of a payment amount between a payer and a payee, typically performed in and by the digital payment system 1 between the aforementioned payer P1 and payee P2. As can be seen from these two latter drawings, the digital payment is performed in two stages. First, an offline settlement 110 takes place, as can be seen particularly in FIG. 2A. Then, an online settlement 130 occurs which can be seen particularly in FIG. 2B. The digital payments performable by the digital payment system 1 and computerized method 100 are thus “offline” digital payments in the sense that they involve an offline stage as well as a subsequent online stage, i.e. a part of each digital payment is performed offline.

The offline settlement stage 110 takes place when the payer communication device PD1 and payee communication device PD2 are in proximity 10 of each other. At the offline settlement stage 110, the payer communication device PD1 is thus configured for generating, for a desired digital payment of a payment amount Amount from the payer P1 to the payee P2, payment transaction data Transaction Data which are being signed with a private cryptographic key priv_key_cust which is associated with the payer communication device digital certificate cert_pub_cust. The payment transaction data Transaction Data includes the payer communication device digital certificate cert_pub_cust, the first payment service provider digital certificate cert_pub_psp1 (in embodiments where this certificate is used), and the payment amount Amount. The payer communication device PD1 is further configured for communicating the payment transaction data Transaction Data to the payee communication device PD2 by short-range data communication.

Still at the offline settlement stage 110, the payee communication device PD2 is correspondingly configured for receiving the payment transaction data Transaction Data from the payer communication device PD1 by short-range data communication. The payee communication device PD2 is moreover configured for validating the payment transaction data Transaction Data to verify the payer communication device's PD1 signature of the payment transaction data Transaction Data by means of the digital certificate cert_pub_cust of the payer communication device PD1.

The payee communication device PD2 is moreover configured, upon successful validation, for accepting the digital payment and buffering the payment transaction data Transaction Data in local storage, the digital payment thereby being settled offline between the payer P1 and payee P2.

Then, during the online settlement stage 130, the payee communication device PD2 is configured for subsequently communicating the buffered payment transaction data Transaction Data to the second payment service provider PSP2 by wide area network communication.

During the online settlement stage 130, the computerized payment network switch NW is configured for receiving the payment transaction data Transaction Data from the second payment service provider PSP2, and for validating the payment transaction data Transaction Data to verify the payer communication device's PD1 signature of the payment transaction data Transaction Data by means of the digital certificate cert_pub_cust of the payer communication device PD1.

Upon successful validation, the computerized payment network switch NW is configured for causing the digital payment to be settled online between the payer P1 and payee P2 as follows. From the payment transaction data Transaction Data, the computerized payment network switch NW first determines a payer identifier id_cust@psp1.nw representing the payer P1, a payee identifier id_merch@psp2.nw representing the payee P2, and the payment amount Amount.

The computerized payment network switch NW then sends a debit instruction to the first payment service provider PSP1 to cause a deduction of funds from the payer account account_P1 of the payer P1, wherein the deduction corresponds to the payment amount Amount. The computerized payment network switch NW moreover sends a credit instruction to the second payment service provider PSP2 to cause an addition of funds to the payee account account_P2 of the payee P2, the addition corresponding to the payment amount Amount.

The functionality described above can be summarized by the aforementioned computerized method 100 shown in FIGS. 2A and 2B. It is recalled that the computerized method 100 is a method of performing a digital payment of a payment amount Amount between a payer P1 and a payee P2. It is also recalled that the payer P1 is provided with a payer communication device PD1 and is associated with a computerized first payment service provider PSP1 that handles a payer account account_P1 of the payer P1, whereas the payee P2 is provided with a payee communication device PD2 and is associated with a computerized second payment service provider PSP2 that handles a payee account account_P2 of the payee P2.

During the offline settlement stage 110 of the computerized method 100, the payer communication device PD1 and payee communication device PD2 communicate at 112 by short-range data communication to generate payment transaction data Transaction Data. The payment transaction data Transaction Data is digitally signed at 114 by the payer communication device PD1 and comprises the payment amount Amount as well as the digital certificate cert_pub_cust of the payer communication device PD1 (and, in applicable embodiments, also the first payment service provider digital certificate cert_pub_psp1 of the first payment service provider PSP1).

The generated payment transaction data Transaction Data is validated at 116 by the payee communication device PD2 to verify the payer communication device's PD1 signature of the payment transaction data Transaction Data by means of the digital certificate cert_pub_cust of the payer communication device PD1.

During the online settlement stage 130 of the computerized method 100, the payee communication device PD2 communicates at 132 the payment transaction data Transaction Data to the second payment service provider PSP2 by wide area network communication. The second payment service provider PSP2 communicates at 134 the payment transaction data Transaction Data to the computerized payment network switch NW.

The computerized payment network switch NW validates at 136 the payment transaction data Transaction Data to verify the payer communication device's PD1 signature of the payment transaction data Transaction Data by means of the digital certificate cert_pub_cust of the payer communication device PD1.

Upon successful validation, see 138, the computerized payment network switch NW determines at 140 from the payment transaction data Transaction Data a payer identifier id_cust@psp1.nw representing the payer P1, a payee identifier id_merch@psp2.nw representing the payee P2, and the payment amount Amount.

The computerized payment network switch NW then, at 142, communicates at least with the first payment service provider PSP1 to cause a deduction of funds from the payer account account_P1 of the payer P1 and an addition of funds to the payee account account_P2 of the payee P2.

The deduction and addition correspond to the payment amount Amount. In some embodiments, the deduction and the addition are equal to the payment amount Amount (i.e., the payment amount Amount is subtracted from the balance of the payer account account_P1 and is added to the balance of the payee account account_P2). In some embodiments, a fee may be charged to the payer account account_P1 and/or payee account account_P2, wherein the deduction and/or addition may not be exactly identical to the payment amount Amount. In some embodiments, there is a currency conversion at the payer side, as will be described in more detail in a later section of this document.

In some embodiments, the computerized payment network switch NW is configured for causing the digital payment to be settled online between the payer P1 and payee P2 by sending a debit instruction to the first payment service provider PSP1 to cause the deduction of funds from the payer account account_P1 of the payer P1, and by sending a credit instruction to the second payment service provider PSP2 to cause an addition of funds to the payee account account_P2 of the payee P2. The debit instruction will typically contain at least the payer identifier id_cust@psp1.nw and the payment amount Amount. The credit instruction will typically contain at least the payee identifier id_merch@psp2.nw and the payment amount Amount.

In other embodiments, the computerized payment network switch NW is configured for causing the digital payment to be settled online between the payer P1 and payee P2 by sending a settlement instruction to the first payment service provider PSP1, wherein the settlement instruction will typically contain the payer identifier id_cust@psp1.nw, the payee identifier id_merch@psp2.nw and the payment amount Amount.

In such embodiments, the first payment service provider PSP1 is configured for receiving the settlement instruction and making the deduction of funds from the payer account account_P1 of the payer P1. Furthermore, in such embodiments, the first payment service provider PSP1 is configured for sending a credit instruction to the second payment service provider PSP2 to cause the addition of funds to the payee account account_P2 of the payee P2.

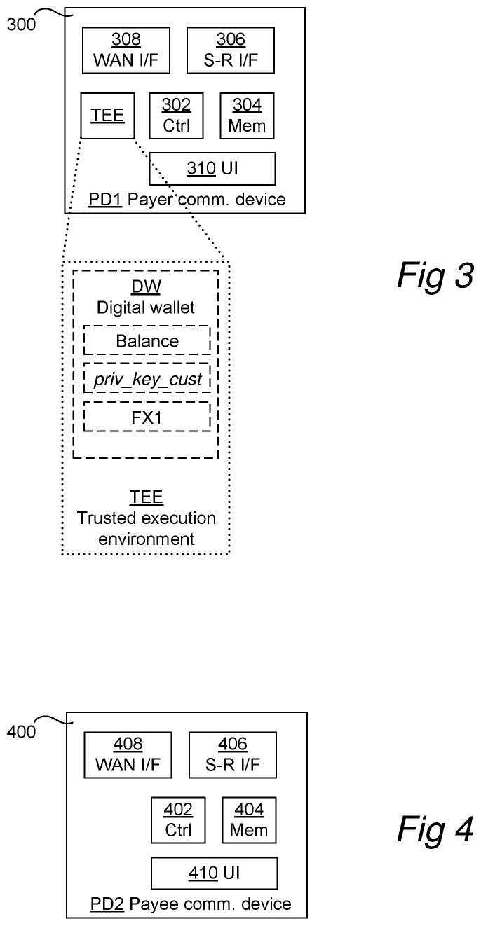

Reference is now being made to FIG. 3 and the communication device 300 illustrated therein. The communication device 300 may implement a payer communication device, like the aforementioned PD1, suitable for use in the digital payment system 1 and computerized method 100. To this end, the communication device 300 comprises a processing device 302, local storage including a memory 304, a short-range data communication interface 306, a wide area network communication interface 308 and a user interface 310.

The processing device 302 acts as a controller of the communication device 300 and may be implemented in any known controller technology, including but not limited to microcontroller, processor (e.g. PLC, CPU, DSP), FPGA, ASIC or any other suitable digital and/or analog circuitry capable of performing the intended functionality.

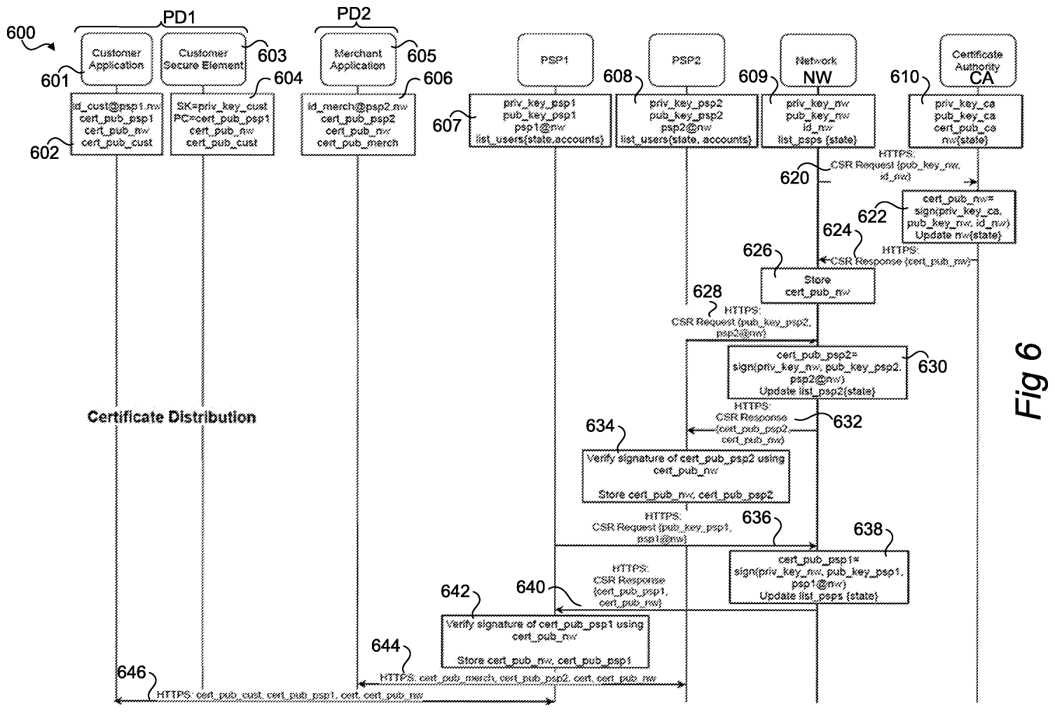

The memory 304 may be implemented in any known memory technology, including but not limited to ROM, RAM, SRAM, DRAM, CMOS, FLASH, DDR, SDRAM or some other memory technology. In some embodiments, the memory or parts thereof may be integrated with or internal to the processing device 302. The memory may store program instruction for execution by the processing device 302 (also see the description of FIG. 5 below), as well as temporary and permanent data for use by the processing device 302.

The short-range data communication interface 306 may be configured for Bluetooth communication, or any other radio-based short-range wireless data communication such as, for instance, Bluetooth Low Energy, RFID, WLAN, WiFi, mesh communication or LTE Direct, without limitation, or any non-radio-based short-range wireless data communication such as, for instance, magnetic communication (such as NFC), (ultra)sound communication, or optical communication (such as IrDA) without limitation. In some embodiments, the short-range data communication interface 306 comprises equipment and functionality for presenting or scanning a QR code.

The wide area network communication interface 308 may be configured for wide area network communication compliant with, for instance, one or more of W-CDMA, GSM, UTRAN, HSPA, LTE, LTE Advanced or 5G, and TCP/IP, and/or WLAN (WiFi), without limitation.

The user interface 310 may comprise an input device and a presentation device, as is generally known per se. In some embodiments, the input device and the presentation device are constituted by one common physical device, such as for instance a touch screen (touch-sensitive display screen), implemented in for instance resistive touch technology, surface capacitive technology, projected capacitive technology, surface acoustic wave technology or infrared technology.

The communication device 300 may further comprise a trusted execution environment TEE, such as a secure element, i.e. a tamper-resistant hardware or virtual platform. In the latter case, the trusted execution environment TEE may be implemented in software and may reside in the local storage or even the memory 304. The trusted execution environment TEE is capable of securely hosting applications and storing confidential and cryptographic data and therefore provides a trusted environment for execution of such applications, a.k.a. secure runtime. Advantageously, some of the data and functionality in embodiments of the invention may be stored in and performed by the trusted execution environment TEE, as will be clear from subsequent sections of this document.

The communication device 300 may hence be configured to perform the functionality of the payer communication device PD1 as defined in and described above for the method 100 and any or all of its embodiments. The payer communication device PD1 may thus be implemented by the communication device 300 in the form of, for instance, a mobile communication device, a mobile phone, a smart phone, a tablet computer, a personal digital assistant, a portable computer, smart glasses, a smart wearable, a smart watch, a smart bracelet, a smart card or a smart chip.

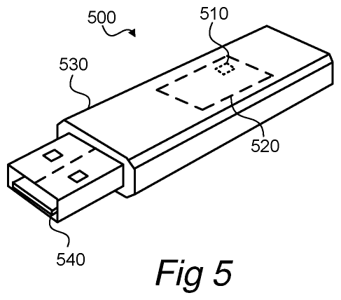

FIG. 4 illustrates a communication device 400 which may implement a payee communication device, like the aforementioned PD2, suitable for use in the digital payment system 1 and computerized method 100. To this end, the communication device 400 comprises a processing device 402, local storage including a memory 404, a short-range data communication interface 406, a wide area network communication interface 408 and a user interface 410.

The processing device 402 acts as a controller of the communication device 400 and may be implemented in much the same way as the processing device 302 referred to above. The memory 404 may be implemented in much the same way as the memory 404 referred to above and may store program instruction for execution by the processing device 402 (also see the description of FIG. 5 below), as well as temporary and permanent data for use by the processing device 402.

The short-range data communication interface 406 and the wide area network communication interface 408 may be implemented in much the same way as the short-range data communication interface 306 and the wide area network communication interface 308 referred to above. The same may apply to the user interface 410 with respect to the user interface 310.

The communication device 400 may hence be configured to perform the functionality of the payee communication device PD2 as defined in and described above for the method 100 and any or all of its embodiments. The payee communication device PD2 may thus be implemented by the communication device 400 in the form of, for instance, a mobile communication device, a mobile phone, a smart phone, a tablet computer, a personal digital assistant, a portable computer, smart glasses, a smart watch, a smart card, a smart bracelet, a smart wearable, a payment terminal, a service terminal, a point-of-sales terminal, a checkout counter, a delivery pickup point, a vending machine, a ticket machine, a dispensing machine, or an access control system.

FIG. 5 is a schematic illustration of a computer-readable medium 500 in one exemplary embodiment, capable of storing a computer program product 510. The computer-readable medium 500 in the disclosed embodiment is a portable memory device, such as a Universal Serial Bus (USB) stick. The computer-readable medium 500 may however be embodied in various other ways instead, as is well-known per se to the skilled person. The portable memory device 500 comprises a housing 530 having an interface, such as a connector 540, and a memory chip 520. In the disclosed embodiment, the memory chip 520 is a flash memory, i.e. a non-volatile data storage that can be electrically erased and re-programmed. The memory chip 520 stores the computer program product 510 which is programmed with computer program code (instructions) that when loaded into a processing device, such as a CPU, will perform any of the functionalities listed in the next paragraph. The processing device may, for instance, be the aforementioned processing device 302 or 402. The portable memory device 500 is arranged to be connected to and read by a reading device for loading the instructions into the processing device. It should be noted that a computer-readable medium can also be other media such as compact discs, digital video discs, hard drives or other memory technologies commonly used. The computer program code (instructions) can also be downloaded from the computer-readable medium via a wireless interface to be loaded into the processing device.

In one embodiment, therefore, the computer program product 510 comprises computer program code for performing the functionality of the payer communication device PD1 in the method 100 as described herein when the computer program code is executed by the processing device. In another embodiment, the computer program product 510 comprises computer program code for performing the functionality of the payee communication device PD2 in the method 100 as described herein when the computer program code is executed by the processing device. In still other embodiments, the computer program product 510 comprises computer program code for performing the functionality of the payment network switch, the first payment service provider or the second payment service provider in the method 100 as described herein when the computer program code is executed by the processing device.

### Refined Embodiments

In some embodiments, the first payment service provider PSP1 is configured, upon deduction of the funds from the payer account account_P1 of the payer P1, to send an online settlement completion report to the payer communication device PD1. The online settlement completion report will thus indicate the deducted funds and serve as useful feedback information to the payer P1.

In some embodiments, each of the payee communication device PD2 and the computerized payment network switch NW is configured for validating the payment transaction data Transaction Data to verify the payer communication device's PD1 signature of the payment transaction data Transaction Data in the following manner. First, the first payment service provider digital certificate cert_pub_psp1 is verified by means of the payment network switch digital certificate cert_pub_nw. Then, the payer communication device digital certificate cert_pub_cust is verified by means of the verified first payment service provider digital certificate cert_pub_psp1. Finally, the payer communication device's PD1 signature of the payment transaction data Transaction Data is verified by means of the verified payer communication device digital certificate cert_pub_cust.

Such embodiments offer a high level of data integrity and trust for the participating parties of the digital payment system 1, thanks to the hierarchy of digital certificates from the leaf level (payer communication device PD1) and upwards, which can be successively verified by the digital certificates of the entities at the respective next levels.

Certificate Distribution

In some embodiments, the digital payment system 1 even comprises a computerized certificate authority CA at a root level, which may be global (see FIG. 1). The certificate authority CA has a certificate authority digital certificate cert_pub_ca, by means of which the payment network switch digital certificate cert_pub_nw can be verified. The certificate authority CA may, for instance, be a central bank, a trusted international organization, or a trusted private enterprise. The provision of the certificate authority CA root level in the digital payment system 1 may also allow additional computerized payment network switches (NW2 . . . NWn (see FIG. 1), each having a respective payment network switch digital certificate which is verifiable with the certificate authority digital certificate cert_pub_ca of the certificate authority CA.

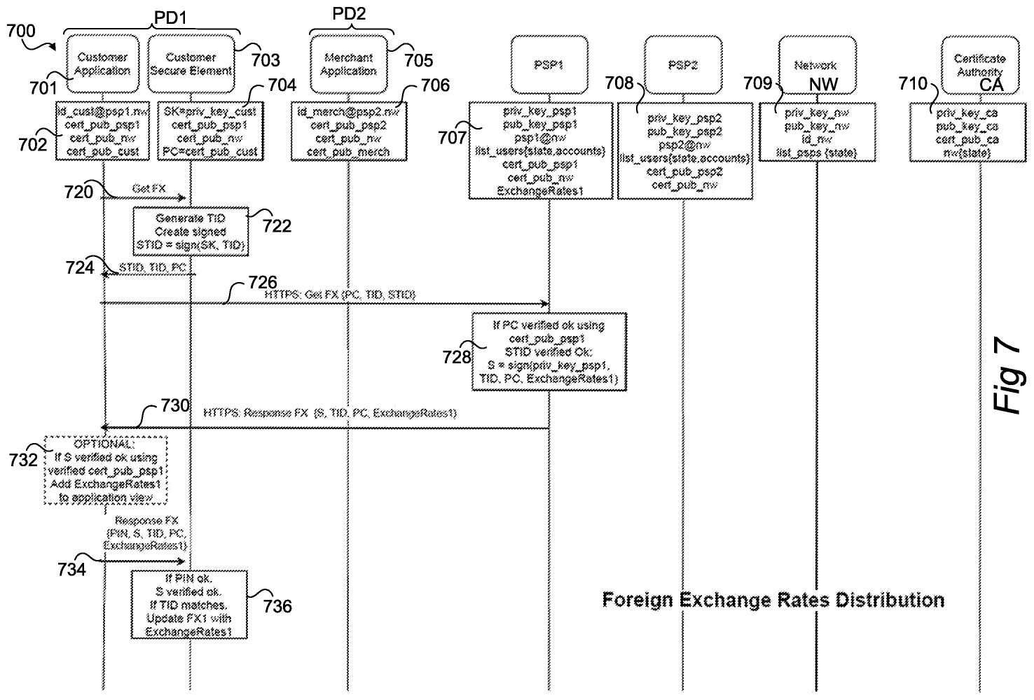

For further details, reference is being made to FIG. 6 which illustrates the distribution of digital certificates in one embodiment 600 of the digital payment system 1. FIG. 6 shows the payer communication device PD1 being provided with a customer application 601 for use by the payer (customer) P1. The customer application 601 will have access to certain data 602, which includes the aforementioned payer identifier id_cust@psp1.nw, as well as some of the digital certificates described above. The customer application 601 may be implemented by software stored in the memory 304 and executed by the processing device 302 of the communication device 300 in FIG. 3. The data 602 may be stored in the memory 304.

The customer application 601 interacts with a customer secure element 603 which may be implemented in or by the aforementioned trusted execution environment TEE (cf. FIG. 3). The customer secure element 603 securely stores data 604, including the aforementioned private cryptographic key priv_key_cust which is associated with the payer communication device digital certificate cert_pub_cust, and the same digital certificates as the customer application 601.

FIG. 6 furthermore shows the payee communication device PD2 being provided with a merchant application 605 for use by the payee (merchant) P2. The merchant application 605 will have access to certain data 606, which includes the aforementioned payee identifier id_merch@ps2.nw, as well as some of the digital certificates described above.

The first payment service provider PSP1 will have access to certain data 607, including a private cryptographic key priv_key_psp1 which is associated with the aforementioned first payment service provider digital certificate cert_pub_psp1, as well as a corresponding public cryptographic key pub_key_psp1. The data 607 also includes an identifier psp1@nw of the first payment service provider PSP1, as well as a list of users (one of which being the payer P1) and their corresponding accounts (one of which being the payer account account_P1).

Correspondingly, the second payment service provider PSP2 will have access to certain data 608, including a private cryptographic key priv_key_psp2 which is associated with the aforementioned second payment service provider digital certificate cert_pub_psp2, as well as a corresponding public cryptographic key pub_key_psp2. The data 608 also includes an identifier psp2@nw of the second payment service provider PSP2, as well as a list of users (one of which being the payee P2) and their corresponding accounts (one of which being the payee account account_P2).

The payment network switch NW will have access to certain data 609, including a private cryptographic key priv_key_nw which is associated with the aforementioned payment network switch digital certificate cert_pub_nw, as well as a corresponding public cryptographic key pub_key_nw. The data 609 also includes an identifier id_nw of the payment network switch NW, as well as a list of payment service providers (including the first and second payment service providers PSP1, PSP2).

The certificate authority CA will have access to certain data 610, including a private cryptographic key priv_key_ca which is associated with the aforementioned certificate authority digital certificate cert_pub_ca, as well as the certificate itself and/or a corresponding public cryptographic key pub_key_ca. The data 610 also includes information on the payment network switch NW, or a list of payment network switches NW, NW2, . . . , in case there are more than one of them in the digital payment system.

The distribution procedure in FIG. 6 starts at 620 with the payment network switch NW sending a certificate signing request 620 to the certificate authority CA, the request including the public cryptographic key pub_key_nw and the identifier id_nw of the payment network switch NW. At 622, the certificate authority CA generates the payment network switch digital certificate cert_pub_nw by signing the received pub_key_nw and id_nw using the private cryptographic key priv_key_ca, and delivering the generated payment network switch digital certificate cert_pub_nw in a certificate signing response 624 to the payment network switch NW. Upon receipt, the payment network switch NW stores at 626 the payment network switch digital certificate cert_pub_nw in the data 609.

At 628, the second payment service provider PSP2 sends a certificate signing request to the payment network switch NW. The request includes the public cryptographic key pub_key_psp2 and the identifier psp2@nw of the second payment service provider PSP2. At 630, the payment network switch NW generates the second payment service provider digital certificate cert_pub_psp2 by signing the received pub_key_psp2 and psp2@nw using the private cryptographic key priv_key_nw, and delivering the generated second payment service provider digital certificate cert_pub_psp2 in a certificate signing response 632 to the second payment service provider PSP2. The network switch digital certificate cert_pub_nw is also included in the response 632.

Upon receipt, as seen at 634, the second payment service provider PSP2 verifies the signature of the received second payment service provider digital certificate cert_pub_psp2 using the network switch digital certificate cert_pub_nw. If the verification is successful, cert_pub_psp2 and cert_pub_nw are stored in the data 608.

At 636-642, the first payment service provider PSP1 retrieves the first payment service provider digital certificate cert_pub_psp1 from the payment network switch NW and stores it together with the network switch digital certificate cert_pub_nw in the data 607, in much the same way as has been described above for the second payment service provider PSP2.

The payee communication device PD2 will then, at 644, retrieve its digital certificate cert_pub_merch together with the second payment service provider digital certificate cert_pub_psp2 and the network switch digital certificate cert_pub_nw from the second payment service provider PSP2, for storing in the data 606.

Correspondingly, at 646, the payer communication device PD1 will retrieve its digital certificate cert_pub_cust together with the first payment service provider digital certificate cert_pub_psp1 and the network switch digital certificate cert_pub_nw from the first payment service provider PSP1, for storing in the data 602-604.

Payer Identifier

In some embodiments, the computerized payment network switch NW is configured for determining the payer identifier id_cust@psp1.nw, that represents the payer P1, from the payer communication device digital certificate cert_pub_cust in the payment transaction data Transaction Data. The payer identifier is therefore protected from manipulation since it is contained in a verifiable digital certificate, namely the payer communication device digital certificate cert_pub_cust. Again, a high level of data integrity and trust is offered.

Payee Certificate

Further enhanced data integrity and trust may be obtained in some embodiments by the following provisions. It is recalled that the computerized second payment service provider PSP2 has its second payment service provider digital certificate cert_pub_psp2 which is verifiable with the payment network switch digital certificate cert_pub_nw. Moreover, the payee communication device PD2 has its payee communication device digital certificate cert_pub_merch which is verifiable with the second payment service provider digital certificate cert_pub_psp2. The payee communication device digital certificate cert_pub_merch is included in the payment transaction data Transaction Data being signed by the payer communication device PD1. In effect, this makes the Transaction Data addressed to the intended receiver, i.e. the payee P2.

Payee Identifier

Advantageously, in such embodiments, the computerized payment network switch NW is configured for determining the payee identifier id_merch@psp2.nw, that represents the payee P2, from the payee communication device digital certificate cert_pub_merch in the payment transaction data Transaction Data. The payee identifier is therefore protected from manipulation since it is contained in a verifiable digital certificate, namely the payee communication device digital certificate cert_pub_merch. Once again, a high level of data integrity and trust is obtained.

Double Sided Buffering of Transaction Data and Initiation of Online Settlement

In some embodiments, the payer communication device PD1 is configured for buffering the generated payment transaction data Transaction Data in local storage at the offline settlement stage 110, and for subsequently communicating the buffered payment transaction data Transaction Data to the first payment service provider PSP1 by wide area network communication at the online settlement stage 130 (i.e., much like the payee communication device PD2 does).

The computerized payment network switch NW is configured for receiving the payment transaction data Transaction Data from the first payment service provider PSP1, and for validating the payment transaction data Transaction Data to verify the payer communication device's PD1 signature of the payment transaction data Transaction Data by means of the digital certificate cert_pub_cust of the payer communication device PD1.

The computerized payment network switch NW is further configured, upon successful validation and unless the digital payment has already been settled online, for causing the digital payment to be settled online between the payer P1 and payee P2 by determining from the payment transaction data Transaction Data a payer identifier id_cust@psp1.nw that represents the payer P1, a payee identifier id_merch@psp2.nw that represents the payee P2, and the payment amount Amount. The computerized payment network switch NW then communicates at least with the first payment service provider PSP1 to cause a deduction of funds from the payer account account_P1 of the payer P1 and an addition of funds to the payee account account_P2 of the payee P2, the deduction and addition corresponding to the payment amount Amount.

This may involve the computerized payment network switch NW sending a debit instruction to the first payment service provider PSP1 to cause the deduction of funds from the payer account account_P1 of the payer P1, as well as sending a credit instruction to the second payment service provider PSP2 to cause the addition of funds to the payee account account_P2 of the payee P2.

Alternatively, it may involve the computerized payment network switch NW sending a settlement instruction to the first payment service provider PSP1, wherein the settlement instruction will typically contain the payer identifier id_cust@psp1.nw, the payee identifier id_merch@psp2.nw and the payment amount Amount. The first payment service provider PSP1 will receive the settlement instruction and make the deduction of funds from the payer account account_P1 of the payer P1. In addition, the first payment service provider PSP1 will send a credit instruction to the second payment service provider PSP2 to cause the addition of funds to the payee account account_P2 of the payee P2.

Such embodiments will be beneficial in that redundancy is added to the digital payment system 1; if the payee communication device PD2 is incapable of wide area network communication with the second payment service provider PSP2 for the time being (for any technical reason), a resulting delay of the online settlement stage 130 can be avoided since the payer communication device PD1 may take care of the part of the online settlement stage 130 that would normally have been performed by the payee communication device PD2.

Embodiments with Local Digital Wallet

Advantageously, the payer communication device PD1 comprises a digital wallet DW which is stored in local storage, preferably in the hardware-based or software-based trusted execution environment TEE (e.g. secure element). The payer communication device PD1 is configured to verify that a current balance Balance of the digital wallet DW is sufficient for the payment amount Amount of the desired digital payment, and, upon successful verification, update the balance Balance of the digital wallet DW to reflect the payment amount Amount of the desired digital payment.

More specifically, in some embodiments the payer communication device PD1 is configured to verify that the current balance Balance of the digital wallet DW is sufficient for the payment amount Amount of the desired digital payment by verifying that the payment amount Amount does not exceed the current balance Balance of the digital wallet DW. The payer communication device PD1 is furthermore configured to update the balance Balance of the digital wallet DW to reflect the payment amount Amount of the desired digital payment by deducting the payment amount Amount from the current balance of the digital wallet DW.

In addition to this, the payer communication device PD1 may be configured to verify that the desired digital payment complies with a risk limit profile of the digital wallet DW. The risk limit profile may be applied by the first payment service provider PSP1 and may, for instance, define one or more of the following constraints:
a total spending limit for digital payments that have not yet been settled;
a maximum payment amount for each digital payment;
a maximum accumulated payment amount for digital payments, and/or a maximum number of digital payments, performable until communicating the contents of the transaction log to the first payment service provider PSP1 (for embodiments where the payer communication device PD1, too, buffers payment transactions as described above);
a maximum accumulated payment amount for digital payments performable during a certain time (such as a day, week, month, etc.);
a maximum number of digital payments performable during a certain time (such as a day, week, month, etc.);
a definition of payment receivers that the payer P1 is allowed to make digital payments to; and
a definition of payment receivers that the payer P1 is not allowed to make digital payments to.

Digital Wallet Replenishment

The payer P1 may request a top-up of the digital wallet DW from the first payment service provider PSP1. Accordingly, the payer communication device PD1 is configured to generate an offline wallet replenishment request comprising a requested replenishment amount and the payer communication device digital certificate cert_pub_cust, sign the offline wallet replenishment request using the private cryptographic key priv_key_cust associated with the payer communication device digital certificate cert_pub_cust, and send the offline wallet replenishment request to the first payment service provider PSP1.

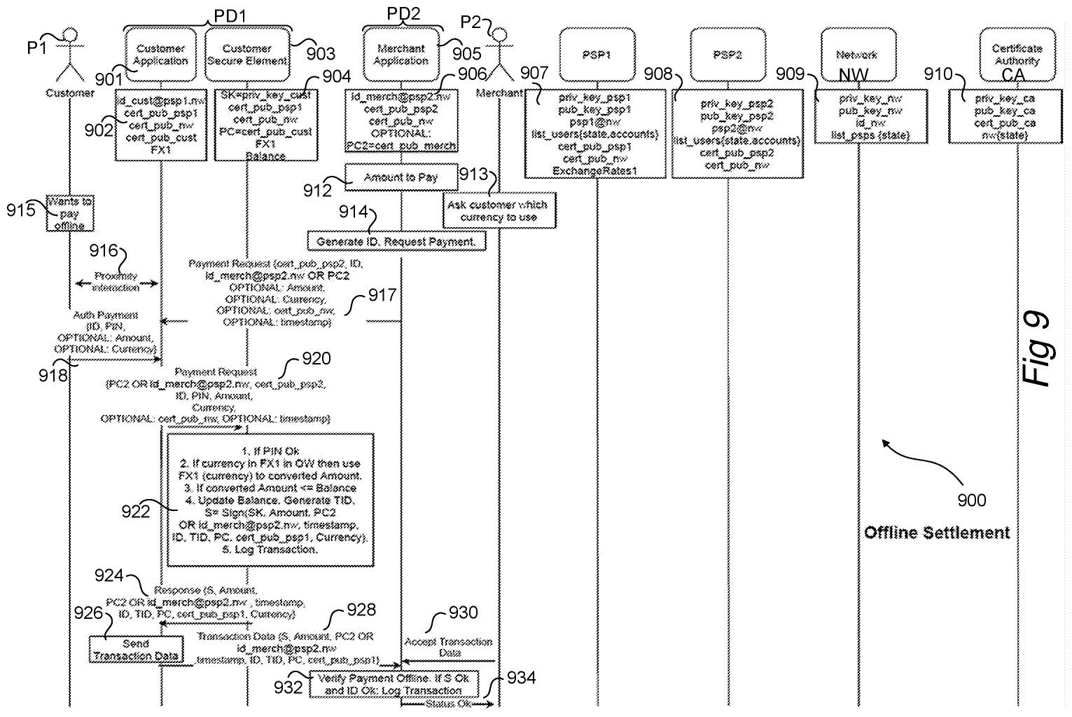

This activity can be seen at 810-818 in FIG. 8. FIG. 8 illustrates a digital payment system 800, being an embodiment of the digital payment system 1. The customer application 801 and its data 802, the customer secure element 803 and its data 804, the merchant application 805 and its data 806, the data 807 of the first payment service provider PSP1, the data 808 of the second payment service provider PSP2, the data 809 of the payment network switch NW and the data 810 of the certificate authority CA, may all be substantially the same as has been described above for entities 601-610 in conjunction with FIG. 6, except when described otherwise in the following sections of this document.

The replenishment activity in FIG. 8 starts with the payer P1 requesting a replenishment amount at 811. The customer application 801 communicates with the customer secure element 803 at 812 and 816 to request and retrieve signed transaction data STID at 814, being signed using the private cryptographic key priv_key_cust (also referred to as SK in FIG. 8). The signed transaction data STID represents the requested replenishment as a transaction between the payer communication device PD1 and the first payment service provider PSP1. The customer application 801 sends an offline wallet replenishment request 818, including the signed transaction data STID, the payer communication device digital certificate cert_pub_cust (also referred to as PC in FIG. 8) and the requested amount, to the first payment service provider PSP1.

The first payment service provider PSP1 is configured to validate, at 820, the offline wallet replenishment request 818 by verifying the payer communication device digital certificate cert_pub_cust by means of a pre-installed certificate (which in some embodiments is the verified first payment service provider digital certificate cert_pub_psp1), and then verifying the payer communication device's PD1 signature of the offline wallet replenishment request by means of the verified payer communication device digital certificate cert_pub_cust. The first payment service provider PSP1 is also configured to validate the signed transaction data STID using the payer communication device digital certificate cert_pub_cust.

The first payment service provider PSP1 is furthermore configured, upon successful validation, to reserve or deduct a granted replenishment amount in or from the payer account account_P1 of the payer P1, wherein the granted replenishment amount is equal to or less than the requested replenishment amount (depending on, for instance the risk limits granted to the payer P1). This, too, can be seen at 820 in FIG. 8.

The first payment service provider PSP1 sends an offline wallet replenishment response 830 to the payer communication device PD1. The offline wallet replenishment response 830 comprises the granted replenishment amount and is signed by a private cryptographic key priv_key_psp1 associated with the first payment service provider digital certificate cert_pub_psp1. The offline wallet replenishment response 830 may further comprise an updated risk limit profile, if applicable.

The payer communication device PD1 is configured to receive the offline wallet replenishment response 830 from the first payment service provider PSP1 at 840-842. As seen at 844, the payer communication device PD1 validates the offline wallet replenishment request 830 by verifying the first payment service provider's PSP1 signature of the offline wallet replenishment response by means of the first payment service provider digital certificate cert_pub_psp1. Upon successful validation, the payer communication device PD1 updates the balance Balance of the digital wallet DW to reflect the granted replenishment amount, and updates the risk limit profile if applicable, The procedure concludes with some affirmative status communication at 850 and 852, eventually notifying the payer P1 of the outcome of the requested top-up.

Offline Settlement—Exemplary Details

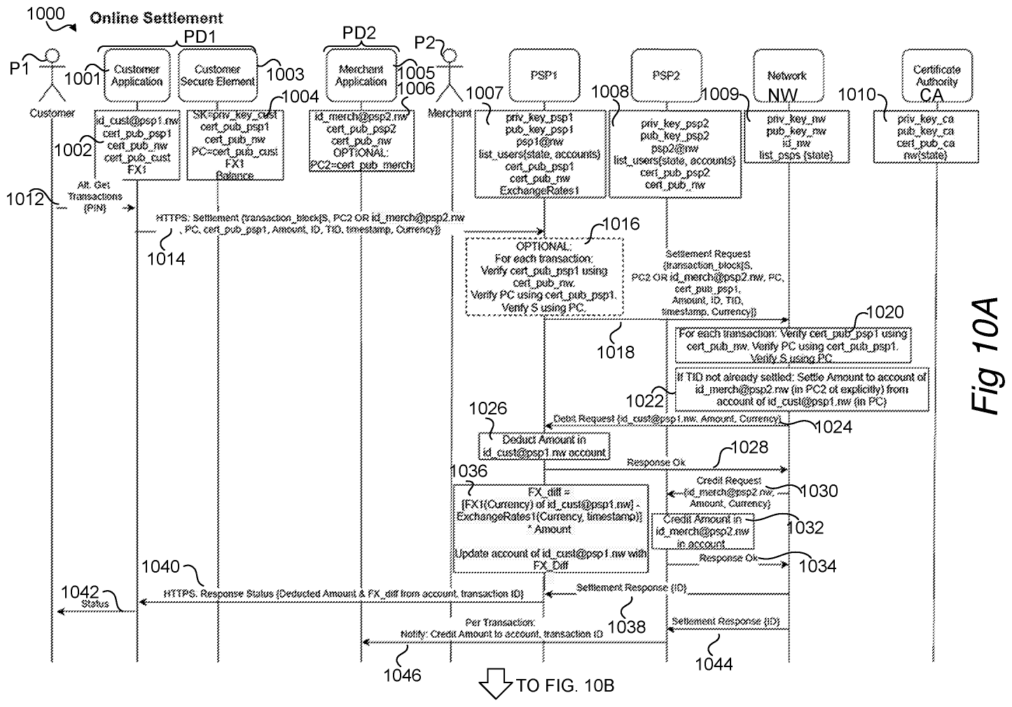

A detailed example of how the offline settlement stage 110 may be performed will now be presented with reference to FIG. 9. FIG. 9 illustrates a digital payment system 900, being an embodiment of the digital payment system 1. The customer application 901 and its data 902, the customer secure element 903 and its data 904, the merchant application 905 and its data 906, the data 907 of the first payment service provider PSP1, the data 908 of the second payment service provider PSP2, the data 909 of the payment network switch NW and the data 910 of the certificate authority CA, may all be substantially the same as has been described above for entities 601-610 in conjunction with FIG. 6, or entities 801-810 of FIG. 8.

At 912, the merchant application 905 presents the amount to the paid, Amount. A payment request 917 is then generated at 914. The payment request may include the second payment service provider digital certificate cert_pub_psp2, an identifier ID for the local offline communication between the devices PD1 and PD, the payee identifier id_merch@psp2.nw (included in the payee communication device digital certificate cert_pub_merch or as separate data), and optionally some additional data.

The payment request 917 is sent to the payer communication device PD1 by short-range data communication. As seen at 916-918, the customer application 901 in the payer communication device PD1 may obtain authorization from the payer P1 in the form of authorization data PIN, which may be a passcode, biometric information, etc.

The customer application 901 and the customer secure element 903 then generate the aforementioned payment transaction data Transaction Data and sends it to the payee communication device PD2 in steps 920-928. As seen at 920, this includes verifying the authorization data PIN, checking and updating the current balance, Balance, of the digit wallet DW, signing the payment transaction data Transaction Data (see S in FIG. 9) using the private cryptographic key priv_key_cust (SK), and buffering the generated payment transaction data Transaction Data in local storage (it is recalled that this may not take place at the payer communication device PD1 in every embodiment of the invention). It is recalled that the payment transaction data Transaction Data includes the payer communication device digital certificate cert_pub_cust (PC) and the payment amount, Amount (and in some embodiments also the first payment service provider digital certificate cert_pub_psp1).

The generated payment transaction data Transaction Data is communicated to the payee communication device PD2 by short-range data communication in steps 926 and 928. Upon receipt, the merchant application 905 in the payee communication device PD2 will validate the payment transaction data Transaction Data to verify the payer communication device's PD1 signature of the payment transaction data Transaction Data by means of the digital certificate cert_pub_cust (PC) of the payer communication device PD1. Upon successful validation, the merchant application 905 will accept the digital payment and log the payment transaction by buffering the payment transaction data Transaction Data in local storage. The digital payment has then been settled offline between the payer P1 and payee P2. The merchant application 905 may have a dialogue with the payee P2 at this stage, as can be seen at 930 and 934.

Online Settlement—Exemplary Details

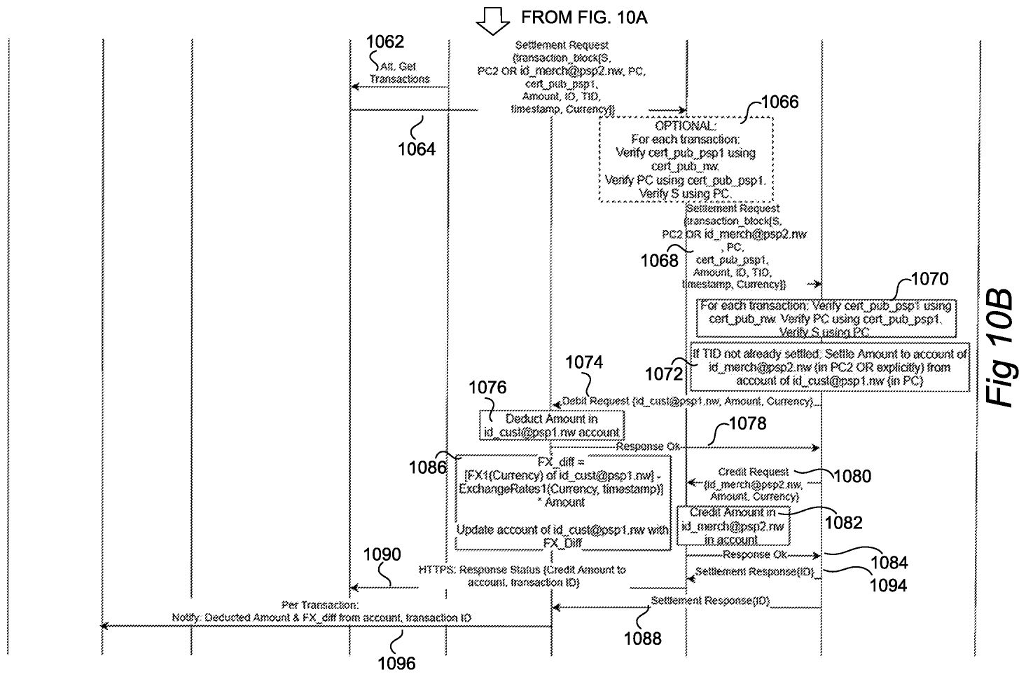

A detailed example of how the online settlement stage 130 may be performed will now be presented with reference to FIGS. 10A and 10B. FIGS. 10A and 10B illustrate a digital payment system 1000, being an embodiment of the digital payment system 1. The customer application 1001 and its data 1002, the customer secure element 1003 and its data 1004, the merchant application 1005 and its data 1006, the data 1007 of the first payment service provider PSP1, the data 1008 of the second payment service provider PSP2, the data 1009 of the payment network switch NW and the data 1010 of the certificate authority CA, may all be substantially the same as has been described above for entities 601-610 in conjunction with FIG. 6, entities 801-810 of FIG. 8 or entities 901-910 of FIG. 9.

FIG. 10A illustrates the online settlement when being initiated by the payer communication device PD1. It is recalled that this is merely an optional functionality that does not have to be available in every embodiment of the invention. FIG. 10B illustrates the online settlement when being initiated by the payee communication device PD2.

Starting with FIG. 10A, the online settlement activity may be initiated in cooperation with the payer P1 (see 1012), or alternatively in an automatic manner (e.g. according to a schedule, when the first opportunity arises, or upon demand from the first payment service provider PSP1). The payer communication device PD1 retrieves any buffered payment transaction data and compiles it into a transaction block. The transaction block may thus contain buffered payment transaction data for one or more digital payments. At 1014, the payer communication device PD1 communicates the transaction block with the buffered payment transaction data Transaction Data to the first payment service provider PSP1 by wide area network communication.

Optionally, at 1016, the first payment service provider PSP1 may verify the payer communication device's PD1 signature S of the payment transaction data Transaction Data (for each transaction in the received transaction block) by verifying the first payment service provider digital certificate cert_pub_psp1 by means of the payment network switch digital certificate cert_pub_nw, verifying the payer communication device digital certificate cert_pub_cust (PC) by means of the verified first payment service provider digital certificate cert_pub_psp1, and verifying the payer communication device's PD1 signature of the payment transaction data Transaction Data by means of the verified payer communication device digital certificate cert_pub_cust (PC). In case of a failed verification, the first payment service provider PSP1 may then refuse to process the payment transaction any further.

At 1018, the first payment service provider PSP1 communicates the received transaction block with the buffered payment transaction data Transaction Data to the computerized payment network switch NW by wide area network communication.

The computerized payment network switch NW receives the transaction block with the payment transaction data Transaction Data from the first payment service provider PSP1. The computerized payment network switch NW validates, at 1020, the payment transaction data Transaction Data for each payment transaction in the received transaction block so as to verify the payer communication device's PD1 signature of the payment transaction data Transaction Data by means of the digital certificate cert_pub_cust of the payer communication device PD1.

More specifically, in the disclosed embodiment, this involves verifying the first payment service provider digital certificate cert_pub_psp1 by means of the payment network switch digital certificate cert_pub_nw, verifying the payer communication device digital certificate cert_pub_cust (PC) by means of the verified first payment service provider digital certificate cert_pub_psp1, and verifying the payer communication device's PD1 signature of the payment transaction data Transaction Data by means of the verified payer communication device digital certificate cert_pub_cust (PC). In case of a failed verification, the computerized payment network switch NW may then refuse to process the payment transaction any further.

Upon successful validation, the computerized payment network switch NW makes sure, at 1022, that the payment transaction in question has not already been settled, and causes the digital payment between the payer P1 and payee P2 to be settled online as follows. As previously described, from the payment transaction data Transaction Data, the computerized payment network switch NW determines the payer identifier id_cust@psp1.nw representing the payer P1, the payee identifier id_merch@psp2.nw representing the payee P2, and the payment amount Amount.

At 1024, the computerized payment network switch NW sends a debit instruction to the first payment service provider PSP1 to cause a deduction of funds from the payer account account_P1 of the payer P1 at 1026, with confirmation being given at 1028.

The computerized payment network switch NW moreover sends a credit instruction at 1030 to the second payment service provider PSP2 to cause an addition of funds to the payee account account_P2 of the payee P2 at 1032, with confirmation being given at 1034.

The computerized payment network switch NW then provides respective settlement responses 1038 and 1044 to the first and second payment service providers PSP1 and PSP2. The settlement responses will be propagated to the payer communication device PD1 and payee communication device PD2, as seen at 1040 (being an online settlement completion report), 1042 and 1046.

Reference is now being made to with FIG. 10B. The online settlement activity may be initiated in cooperation with the payee P2 (see 1062), or alternatively in an automatic manner (e.g. according to a schedule, when the first opportunity arises, or upon demand from the first payment service provider PSP1). The payee communication device PD2 retrieves any buffered payment transaction data and compiles it into a transaction block. Just like in FIG. 10A, the transaction block may contain buffered payment transaction data for one or more digital payments. At 1064, the payee communication device PD2 communicates the transaction block with the buffered payment transaction data Transaction Data to the second payment service provider PSP2 by wide area network communication.

Optionally, at 1066, the second payment service provider PSP1 may verify the payer communication device's PD1 signature S of the payment transaction data Transaction Data (for each transaction in the received transaction block) by verifying the first payment service provider digital certificate cert_pub_psp1 by means of the payment network switch digital certificate cert_pub_nw, verifying the payer communication device digital certificate cert_pub_cust (PC) by means of the verified first payment service provider digital certificate cert_pub_psp1, and verifying the payer communication device's PD1 signature of the payment transaction data Transaction Data by means of the verified payer communication device digital certificate cert_pub_cust (PC). In case of a failed verification, the second payment service provider PSP2 may then refuse to process the payment transaction any further.

At 1068, the second payment service provider PSP2 communicates the received transaction block with the buffered payment transaction data Transaction Data to the computerized payment network switch NW by wide area network communication.

The computerized payment network switch NW receives the transaction block with the payment transaction data Transaction Data from the second payment service provider PSP2. The computerized payment network switch NW validates, at 1070, the payment transaction data Transaction Data for each payment transaction in the received transaction block so as to verify the payer communication device's PD1 signature of the payment transaction data Transaction Data by means of the digital certificate cert_pub_cust of the payer communication device PD1. Like in FIG. 10A, this may specifically involve verifying the first payment service provider digital certificate cert_pub_psp1 by means of the payment network switch digital certificate cert_pub_nw, verifying the payer communication device digital certificate cert_pub_cust (PC) by means of the verified first payment service provider digital certificate cert_pub_psp1, and verifying the payer communication device's PD1 signature of the payment transaction data Transaction Data by means of the verified payer communication device digital certificate cert_pub_cust (PC). In case of a failed verification, the computerized payment network switch NW may refuse to process the payment transaction any further.

Upon successful validation, the computerized payment network switch NW makes sure, at 1082, that the payment transaction in question has not already been settled, and causes the digital payment between the payer P1 and payee P2 to be settled online in the corresponding way as in FIG. 10A. The computerized payment network switch NW determines the payer identifier id_cust@psp1.nw representing the payer P1, the payee identifier id_merch@psp2.nw representing the payee P2, and the payment amount Amount from the payment transaction data Transaction Data.

At 1074, the computerized payment network switch NW sends a debit instruction to the first payment service provider PSP1 to cause a deduction of funds from the payer account account_P1 of the payer Pb at 1076, with confirmation being given at 1078.

The computerized payment network switch NW moreover sends a credit instruction at 1080 to the second payment service provider PSP2 to cause an addition of funds to the payee account account_P2 of the payee P2 at 1082, with confirmation being given at 1084.

The computerized payment network switch NW then provides respective settlement responses 1088 and 1094 to the first and second payment service providers PSP1 and PSP2. The settlement responses will be propagated to the payer communication device PD1 and payee communication device PD2, as seen at 1090 (being an online settlement completion report) and 1096.

Multi-Currency Support

Beneficial embodiments of the digital payment system 1 has multi-currency support that allows the payer P1 to make a digital payment to the payee P2, even when the payer's P1 digital wallet OW uses one currency and the payee P2 is only prepared to accept payments in another currency.

Hence, in these beneficial embodiments of the digital payment system 1, the digital wallet DW of the payer communication device PD1 has a payer currency being a base currency for the balance of the digital wallet DW as well as for the payer account account_P1 of the payer P1 handled by the first payment service provider PSP1. The payer communication device PD1 is configured to keep an exchange rate list FX1 in local storage, see data 902 and 1002 in FIGS. 9 and 10A. The payment amount Amount of the desired digital payment is defined in a payee currency, different from the payer currency. The payee currency is a base currency of the payee communication device PD2.

During offline settlement 110, the payer communication device PD1 is configured to determine whether the payee currency is represented in the exchange rate list FX1 kept in local storage. See item 2 in box 922 in FIG. 9. Upon successful determination, the payer communication device PD1 is configured to establish a first converted amount by converting the payment amount Amount of the desired digital payment into the base currency of the digital wallet DW using an exchange rate between the payee currency and the payer currency specified in the exchange rate list FX1 kept in local storage.

The payer communication device PD1 is further configured to use the first converted amount for verifying that the current balance Balance of the digital wallet DW is sufficient for the payment amount Amount of the desired digital payment (see item 3 in box 922), and to use the first converted amount for updating the balance Balance of the digital wallet DW to reflect the payment amount Amount of the desired digital payment by deducting the first converted amount from the current balance of the digital wallet DW (see item 4 in box 922). The payer communication device PD1 is moreover configured to include the payment amount Amount of the desired digital payment, the payee currency and a timestamp in the generated payment transaction data Transaction Data.

During online settlement 130, the computerized payment network switch NW is further configured, when causing the digital payment to be settled online between the payer P1 and payee P2, to determine the payee currency and the timestamp from the payment transaction data Transaction Data, and include the determined payee currency and the timestamp in the debit instruction (or, in alternative embodiments, the settlement instruction) sent to the first payment service provider PSP1. See 1024 in FIG. 10A and 1074 in FIG. 10B.

The first payment service provider PSP1 is configured to establish a second converted amount by converting the payment amount Amount of the desired digital payment into the base currency of the payer account account_P1 of the payer P1 using an exchange rate between the payee currency and the base currency applicable at a moment in time indicated by the timestamp, and deduct the second converted amount from the payer account account_P1 of the payer P1. See 1026 in FIG. 10A and 1076 in FIG. 10B.

The first payment service provider PSP1 may be further configured to determine an amount deviation between the first converted amount and second converted amount, see 1036 in FIG. 10A and 1086 in FIG. 10B. The determined amount deviation may be included in the online settlement completion report 1040 sent to the payer communication device PD1. The payer communication device PD1 may be configured to receive the online settlement completion report 1040 sent by the first payment service provider PSP1, and notify the payer P1 (see 1042 in FIG. 10A) of the amount deviation as included in the received online settlement completion report.

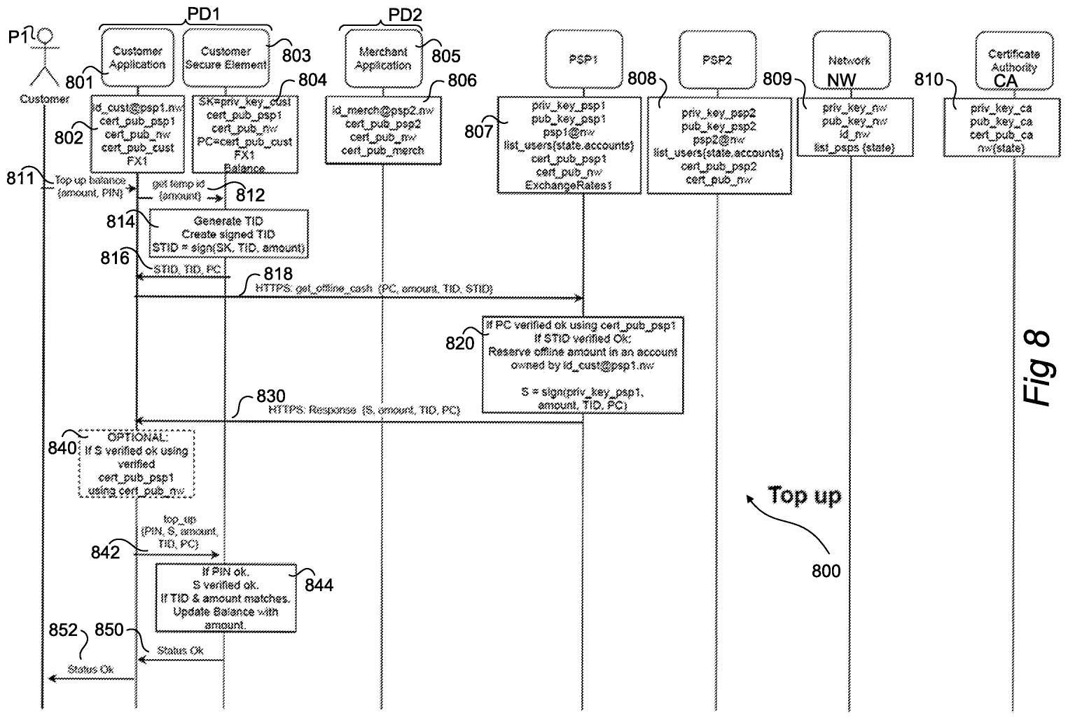

FIG. 7 illustrates distribution of foreign exchange rates in one embodiment 700 of the digital payment system 1 according to the present disclosure, suitable for use with the multi-currency embodiments referred to above. The customer application 701 and its data 702, the customer secure element 703 and its data 704, the merchant application 705 and its data 706, the data 707 of the first payment service provider PSP1, the data 708 of the second payment service provider PSP2, the data 709 of the payment network switch NW and the data 710 of the certificate authority CA, may all be substantially the same as has been described above for entities 601-610 in conjunction with FIG. 6, entities 801-810 of FIG. 8, entities 901-910 of FIG. 9 or entities 1001-1010 of FIGS. 10A and 10B.

As can be seen at steps 720-736, the payer communication device PD1 communicates with the first payment service provider PSP1 by wide area network communication to retrieve current exchange rates ExchangeRates1. The retrieved current exchange rates ExchangeRates1 are used for the purpose of updating the exchange rate list FX1 in the payer communication device's PD1 local storage. This functionality may, for instance, be performed upon request from the payer P1, according to a schedule, when the first opportunity arises, in connection with online settlement 130, or upon demand from the first payment service provider PSP1.

The currencies referred to in this document may be official monetary currencies like, for instance, SEK, EUR, USD, etc., digital currencies like CBDC (Central Bank Digital Currency) or crypto currencies (blockchain-based distributed ledger technology), or combinations thereof.

In one aspect, the invention is considered to be particularly well suited for implementing CBDC. Central banks in numerous countries are experimenting with digital currency using “tokenized value instruments” that represent physical banknotes in digital form. The present invention, in contrast, uses “tokenized transaction instruments”, which may be compared to banker's cheques. Whereas a banknote is a representation of “money”, a banker's cheque represents a “money transfer” between two parties.

Thanks to the present invention, it can be foreseen that digitizing “money transfers” instead of “money” will simplify CBDC implementations tremendously, as will not require any additional architectures. The “tokenized transaction instrument” approach suggested by the present Applicant in and by this document will provide all necessary properties of physical cash; robustness, ease of use and preservation of the payer's integrity in relation to banks. To issue its fiat currency. the central bank may simply deposit it into a centrally held bank account and invite commercial banks (like the payment service provides PSP1, PSP2, . . . ) to access and distribute it by means of regular transactions on the existing digital rails.

### CONCLUDING REMARKS

The cloud-based computing resources as referred to in this document may for instance be implemented as one or more physical server computers or computer systems, or one or more distributed networks of computing resources.

The digital certificates referred to in this document may, for instance, be DERencoded X.509-based certificates which comprise public cryptographic keys for the respective entities of the digital payment system 1, as described above.

When reference in this document is being made to a private cryptographic key which is associated with a particular digital certificate, this includes a case where the particular digital certificate comprises a public cryptographic key, and where the private (secure) cryptographic key and the public cryptographic key together constitute a cryptographic key pair as is generally known for asymmetric data encryption and decryption.

1. A digital payment system enabling payment service provider interoperability for digital payments between proximate users, the system comprising:
a computerized payment network switch;
a computerized first payment service provider handling a payer account of a payer,
a computerized second payment service provider handling a payee account of a payee;
a payer communication device for use by the payer and having a payer communication device digital certificate being verifiable with a pre-installed certificate; and
a payee communication device for use by the payee, wherein:
the payer communication device, upon being in proximity of the payee communication device, is configured for:
generating, for a desired digital payment of a payment amount from the payer to the payee, payment transaction data being signed with a private cryptographic key associated with the payer communication device digital certificate, wherein the payment transaction data includes the payer communication device digital certificate and the payment amount; and
communicating the payment transaction data to the payee communication device by short-range data communication;
the payee communication device is configured for:
receiving the payment transaction data from the payer communication device by short-range data communication;
validating the payment transaction data to verify the payer communication device's signature of the payment transaction data by means of the digital certificate of the payer communication device;
upon successful validation, accepting the digital payment and buffering the payment transaction data in local storage, the digital payment thereby being settled offline between the payer and payee; and
subsequently communicating the buffered payment transaction data to the second payment service provider by wide area network communication;
the computerized payment network switch is configured for:
receiving the payment transaction data from the second payment service provider;
validating the payment transaction data to verify the payer communication device's signature of the payment transaction data by means of the digital certificate of the payer communication device;
upon successful validation, causing the digital payment to be settled online between the payer and payee by:
determining from the payment transaction data a payer identifier representing the payer, a payee identifier representing the payee, and the payment amount; and
communicating at least with the first payment service provider to cause a deduction of funds from the payer account of the payer and an addition of funds to the payee account of the payee, the deduction and addition corresponding to the payment amount.

2. The digital payment system according to claim 1, wherein each of the payee communication device and the computerized payment network switch is configured for validating the payment transaction data to verify the payer communication device's signature of the payment transaction data by:
verifying the payer communication device digital certificate by means of a pre-installed certificate; and
verifying the payer communication device's signature of the payment transaction data by means of the verified payer communication device digital certificate.

3. The digital payment system according to claim 1, wherein the computerized payment network switch is configured for determining the payer identifier representing the payer from the payer communication device digital certificate in the payment transaction data.

4. The digital payment system according to claim 1, wherein the computerized payment network switch is configured for causing the digital payment to be settled online between the payer and payee by:
sending a debit instruction to the first payment service provider to cause a deduction of funds from the payer account of the payer, the deduction corresponding to the payment amount; and
sending a credit instruction to the second payment service provider to cause an addition of funds to the payee account of the payee, the addition corresponding to the payment amount.

5. The digital payment system according to claim 1,
wherein the computerized payment network switch is configured for causing the digital payment to be settled online between the payer and payee by:
sending a settlement instruction to the first payment service provider, the settlement instruction containing the payer identifier, the payee identifier and the payment amount; and
wherein the first payment service provider is configured for:
receiving the settlement instruction;
making a deduction of funds from the payer account of the payer, the deduction corresponding to the payment amount; and
sending a credit instruction to the second payment service provider to cause an addition of funds to the payee account of the payee, the addition corresponding to the payment amount.

6. The digital payment system according to claim 1, wherein:
the payee communication device has a payee communication device digital certificate being verifiable with a pre-installed certificate; and
the payee communication device digital certificate is included in the payment transaction data being signed by the payer communication device.

7. The digital payment system according to claim 6, wherein the computerized payment network switch is configured for determining the payee identifier representing the payee from the payee communication device digital certificate in the payment transaction data.

8. The digital payment system according to claim 1,
wherein the payer communication device is configured for:
buffering the generated payment transaction data in local storage; and
subsequently communicating the buffered payment transaction data to the first payment service provider by wide area network communication; and
wherein the computerized payment network switch is configured for:
receiving the payment transaction data from the first payment service provider;
validating the payment transaction data to verify the payer communication device's signature of the payment transaction data by means of the digital certificate of the payer communication device;
upon successful validation and unless the digital payment has already been settled online, causing the digital payment to be settled online between the payer and payee by:
determining from the payment transaction data a payer identifier representing the payer, a payee identifier representing the payee, and the payment amount; and
communicating at least with the first payment service provider to cause a deduction of funds from the payer account of the payer and an addition of funds to the payee account of the payee, the deduction and addition corresponding to the payment amount.

9. The digital payment system according to claim 1, wherein the first payment service provider is configured, upon deduction of the funds from the payer account of the payer, to send an online settlement completion report to the payer communication device, the online settlement completion report indicating the deducted funds.

10. The digital payment system according to claim 1, wherein the payer communication device comprises a digital wallet stored in local storage, preferably in a hardware-based or software-based trusted execution environment such as a Secure Element, and wherein the payer communication device is configured to:
verify that a current balance of the digital wallet is sufficient for the payment amount of the desired digital payment; and, upon successful verification:
update the balance of the digital wallet to reflect the payment amount of the desired digital payment.

11. The digital payment system according to claim 10,
wherein the payer communication device is configured to:
generate an offline wallet replenishment request comprising a requested replenishment amount and the payer communication device digital certificate;
sign the offline wallet replenishment request using the private cryptographic key associated with the payer communication device digital certificate; and
send the offline wallet replenishment request to the first payment service provider;
wherein the first payment service provider is configured to:
validate the offline wallet replenishment request by:
verifying the payer communication device digital certificate by means of the verified first payment service provider digital certificate; and
verifying the payer communication device's signature of the offline wallet replenishment request by means of the verified payer communication device digital certificate; and
upon successful validation:
reserve or deduct a granted replenishment amount in or from the payer account of the payer the granted replenishment amount being equal to or less than the requested replenishment amount; and
send an offline wallet replenishment response to the payer communication device, the offline wallet replenishment response comprising the granted replenishment amount and being signed by a private cryptographic key associated with the first payment service provider digital certificate; and
wherein the payer communication device is further configured to:
receive the offline wallet replenishment response from the first payment service provider;
validate the offline wallet replenishment response by verifying the first payment service provider's signature of the offline wallet replenishment response by means of the first payment service provider digital certificate; and
upon successful validation, update the balance of the digital wallet to reflect the granted replenishment amount.

12. The digital payment system according to claim 10,
wherein the payer communication device is configured to verify that the current balance of the digital wallet is sufficient for the payment amount of the desired digital payment by verifying that the payment amount does not exceed the current balance of the digital wallet; and
wherein the payer communication device is configured to update the balance of the digital wallet to reflect the payment amount of the desired digital payment by deducting the payment amount from the current balance of the digital wallet.

13. The digital payment system according to claim 10, the digital wallet of the payer communication device having a payer currency being a base currency for the balance of the digital wallet and the payer account of the payer handled by the first payment service provider, wherein:
the payer communication device is configured to keep an exchange rate list in local storage;
the payment amount of the desired digital payment is defined in a payee currency, different from the payer currency, the payee currency being a base currency of the payee communication device; and
the payer communication device is configured to:
determine whether the payee currency is represented in the exchange rate list kept in local storage; and
upon successful determination:
establish a first converted amount by converting the payment amount of the desired digital payment into the base currency of the digital wallet using an exchange rate between the payee currency and the payer currency specified in the exchange rate list kept in local storage;
use the first converted amount for verifying that the current balance of the digital wallet is sufficient for the payment amount of the desired digital payment;
use the first converted amount for updating the balance of the digital wallet to reflect the payment amount of the desired digital payment by deducting the first converted amount from the current balance of the digital wallet; and
include the payment amount of the desired digital payment, the payee currency and a timestamp in the generated payment transaction data.

14. The digital payment system according to claim 13,
wherein the computerized payment network switch is further configured, when causing the digital payment to be settled online between the payer and payee, to:
determine the payee currency and the timestamp from the payment transaction data; and
include the determined payee currency and the timestamp in the debit instruction or settlement instruction sent to the first payment service provider; and
wherein the first payment service provider is configured to:
establish a second converted amount by converting the payment amount of the desired digital payment into the base currency of the payer account of the payer using an exchange rate between the payee currency and the base currency applicable at a moment in time indicated by the timestamp; and
deduct the second converted amount from the payer account of the payer.

15. The digital payment system according to claim 9,
wherein the computerized payment network switch is further configured, when causing the digital payment to be settled online between the payer and payee, to:
determine the payee currency and the timestamp from the payment transaction data; and
include the determined payee currency and the timestamp in the debit instruction or settlement instruction sent to the first payment service provider;
wherein the first payment service provider is configured to:
establish a second converted amount by converting the payment amount of the desired digital payment into the base currency of the payer account of the payer using an exchange rate between the payee currency and the base currency applicable at a moment in time indicated by the timestamp; and
deduct the second converted amount from the payer account of the payer; and
wherein the first payment service provider is further configured to:
determine an amount deviation between the first converted amount and second converted amount; and
include the determined amount deviation in the online settlement completion report sent to the payer communication device.

16. The digital payment system according to claim 15, wherein the payer communication device is configured to:
receive the online settlement completion report sent by the first payment service provider; and
notify the payer of the amount deviation as included in the received online settlement completion report.

17. The digital payment system according to claim 1, further comprising a computerized certificate authority having a certificate authority digital certificate, the pre-installed certificate being verifiable with the certificate authority digital certificate.

18. (canceled)

19. (canceled)

20. (canceled)

21. A computerized method of performing a digital payment of a payment amount between a payer and a payee, the payer being provided with a payer communication device and being associated with a computerized first payment service provider that handles a payer account of the payer, the payee being provided with a payee communication device and being associated with a computerized second payment service provider that handles a payee account of the payee, the method involving:
an offline settlement stage during which:
the payer communication device and payee communication device communicate by short-range data communication to generate payment transaction data, the payment transaction data being digitally signed by the payer communication device and comprising the payment amount as well as a digital certificate of the payer communication device, the generated payment transaction data being validated by the payee communication device to verify the payer communication device's signature of the payment transaction data by means of the digital certificate of the payer communication device; and
an online settlement stage during which:
the payee communication device communicates the payment transaction data to the second payment service provider by wide area network communication;
the second payment service provider communicates the payment transaction data to a computerized payment network switch;
the computerized payment network switch validates the payment transaction data to verify the payer communication device's signature of the payment transaction data by means of the digital certificate of the payer communication device; and
the computerized payment network switch, upon successful validation:
determines from the payment transaction data a payer identifier representing the payer, a payee identifier representing the payee, and the payment amount; and
communicating at least with the first payment service provider to cause a deduction of funds from the payer account of the payer and an addition of funds to the payee account of the payee, the deduction and addition corresponding to the payment amount.

22. (canceled)

23. A cloud-based computing resource configured to perform the functionality of the payment network switch in the digital payment system as defined by in claim 1.

24. A cloud-based computing resource configured to perform the functionality of the first payment service provider in the digital payment system as defined in claim 1.

25. A cloud-based computing resource configured to perform the functionality of the second payment service provider in the digital payment system as defined in claim 1.

26. A communication device configured to perform the functionality of the payer communication device in the digital payment system as defined in claim 1, wherein the communication device is one of the following: a mobile communication device; a mobile phone; a smart phone; a tablet computer; a personal digital assistant a portable computer; smart glasses; a smart wearable; a smart watch; a smart bracelet a smart card; and a smart chip.

27. (canceled)

28. A communication device configured to perform the functionality of the payee communication device in the digital payment system as defined in claim 1, wherein the communication device is one of the following: a mobile communication device; a mobile phone; a smart phone; a tablet computer; a personal digital assistant a portable computer; smart glasses; a smart watch; a smart card; a smart bracelet a smart wearable; a payment terminal, a service terminal; a point-of-sales terminal; a checkout counter; a delivery pickup point a vending machine; a ticket machine; a dispensing machine; and an access control system.

29-34. (canceled)

35. A non-volatile computer readable medium having stored thereon a computer program comprising computer program code for performing the functionality of the payment network switch in the method according to claim 21 when the computer program code is executed by a processing device.

36. A non-volatile computer readable medium having stored thereon a computer program comprising computer program code for performing the functionality of the first payment service provider in the method according to claim 21 when the computer program code is executed by a processing device.

37. A non-volatile computer readable medium having stored thereon a computer program comprising computer program code for performing the functionality of the second payment service provider in the method according to claim 21 when the computer program code is executed by a processing device.

38. A non-volatile computer readable medium having stored thereon a computer program comprising computer program code for performing the functionality of the payer communication device in the method according to claim 21 when the computer program code is executed by a processing device.

39. A non-volatile computer readable medium having stored thereon a computer program comprising computer program code for performing the functionality of the payee communication device in the method according to claim 21 when the computer program code is executed by a processing device.
